(19) United States
(12) Patent Application Publication
(10) Pub. No.: US 2009/0312103 A1
(43) Pub. Date: Dec. 17, 2009

(54) INTERACTIVE LIVE SPORTS GAME WATCHING SYSTEM AND GAME WATCHING DEVICE THEREFOR

(75) Inventor: Samuel T. CHEN, Taipei City (TW)

Correspondence Address: Muncy, Geissler, Olds & Lowe, PLLC, P.O. BOX 1364, FAIRFAX, VA, 22038-1364, US

(73) Assignee: d-Media System Co., Ltd.

(21) Appl. No.: 12/137,965

(22) Filed: Jun. 12, 2008

(51) Int. Cl. A63F 13/12; A63F 13/00; A63F 9/24

(52) U.S. Cl. 463/41; 463/43; 463/42

(57) ABSTRACT

An interactive live sports game watching system includes a game web server internally built a plurality of game-related web pages showing user-accessible game information, and at least one remote game watching device linked with the game web server for receiving live sports games telecasting and entering the game-related pages to search for game information or input predicted results of an underway game and bet corresponding membership points on the game. The game web server compares the predicted results with real results and counts points added to or deducted from the membership points. Therefore, a user may watch the live sports game while looking for basic information about the parties in the game or historic events in connection with the game, and get more fun from predicting and betting on the game.

### FIELD OF THE INVENTION

The present invention relates to a live sports game watching system and game watching device therefor, and more particularly to an interactive live sports game watching system that includes at least one remote game watching device linked therewith, allowing a user to watch a live sports game telecasting on the game watching device and look for game-related information, input predicted results of the game, and bet on the game at the same time.

### BACKGROUND OF THE INVENTION

Playing online games is a very common recreational activity among people who live in the busy modern society. There are also many stationary game machines mounted at various recreational resorts to amuse consumers. Both the online games and the stationary game machines work by running game programs. The programs and rules for online games and game machines are specially designed and are not always fair to players.

The real fair recreational games are those open exercises and athletics, such as baseball games held by Major League Baseball (MLB), basketball games held by National Basketball Association (NBA), etc., and those international games or matches, such as World Tennis Tournament, European Football Championship, World Golf Tournament, Asia games, Olympic games, FIA Formula 1 Grand Prix World Championship, etc.

On the other hand, with the advancement in scientific technologies, various kinds of light, compact, multifunctional, and personalized electronic products, such as mobile phones, personal digital assistants (PDAs), notebook computers, personal multimedia players, etc., have been developed to satisfy the requirements of easy to carry and low in price. These advanced electronic products have also been combined with wireless transmission techniques, such as WiMAX technique, 3G/3.5G Mobile Phone technique, Digital Television of Digital Video Broadcasting (DVB) technique, etc. Therefore, based on the nowadays available electronic and communication technologies, it is no longer a difficult thing to watch the above-mentioned open games on a suitable electronic product in real time. For example, a consumer may now watch live telecasting of Olympic Games on a mobile phone.

Since watching the various kinds of open exercises or games is an important leisure activity among most people, it seems not enough for one to just watch the games. It would be more interesting if a fan is allowed to look for rules of a game, basic information about the parties participating in the game, and historic events in connection with the game while watching the game. For example, when watching a live telecasting of MLB 2008 World Series New York Yankees vs. Cleveland Indians, it would be more interesting if the fan could interact with the electronic product to obtain some basic information about the pitcher Chien-Ming Wang or the batter Bob Abreu, including their winning records, batting percentage, safe hits, etc. However, up to date, there is not any game watching system or device allowing the user to interact with it in real time.

It is therefore tried by the inventor to combine digital TV (DVB) technique with wireless broadband transmission technique to develop an interactive live sports game watching system and a game watching device therefor, so that a user watching a live game telecasting may at the same time look for basic information about the parties participating in the game and historic events in connection with the game via the game watching device. Moreover, the user is allowed to input predicted results of an underway game, including the results at different stages of the game and the final result of the game, and to bet on the game; and the interactive game watching system is able to compare the predicted results with the real results and give or deduct points to and from the user. Therefore, the user gets more fun from watching the game.

### SUMMARY OF THE INVENTION

A primary object of the present invention is to provide an interactive live sports game watching system and a game watching device therefor, so as to provide a platform on which a user may watch a live sports game telecasting while looking for basic information about the parties participating in the game and historic events in connection with the game, inputting predicted results of the game, and betting corresponding membership points on the game to increase the fun in watching the game.

To achieve the above and other objects, the interactive live sports game watching system according to the present invention includes a game web server internally built a plurality of game-related web pages, each of which includes user-accessible game information about a particular game, and the game web server allowing a user to input personally predicted results of an underway game and bet corresponding membership points on the game, and then comparing the predicted results with real results of the game and counting points to be added to or deducted from the user's membership points; and at least one remote game watching device being linked with the game web server for receiving a live sports game telecasting from the game web server, entering the game-related web pages to search for related game information or input predicted results of an underway game and bet corresponding membership points on the game.

Another object of the present invention is to provide an interactive live sports game watching device, via which a user may watch live sports game telecasting transmitted from a game web server, search for game-related information, input predicted results of an underway game, and bet membership points on the game.

To achieve the above and other objects, the interactive live sports game watching device according to the present invention includes an audio/video (AV) receiving module for receiving audio and video signals of the live sports game telecasting; a broadband transmission module for linking with the game web server; and a user-interface including a display module and a sound output module for viewing and controlling the live sports game telecasting. Wherein, the display module includes a playing window and/or a browsing window. The live sports game telecasting is viewed on the playing window, and the game-related information is shown on the browsing window through operation on an input module of the user-interface. The input module also allows a user to input predicted results of an underway game and bet the membership points on the game.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 shows a system configuration of the present invention;

FIG. 2 shows a live sports game watching device according to an embodiment of the present invention; and

FIG. 3 is a block diagram of the live sports game watching device of FIG. 2.

### DETAILED DESCRIPTION OF THE PREFERRED EMBODIMENTS

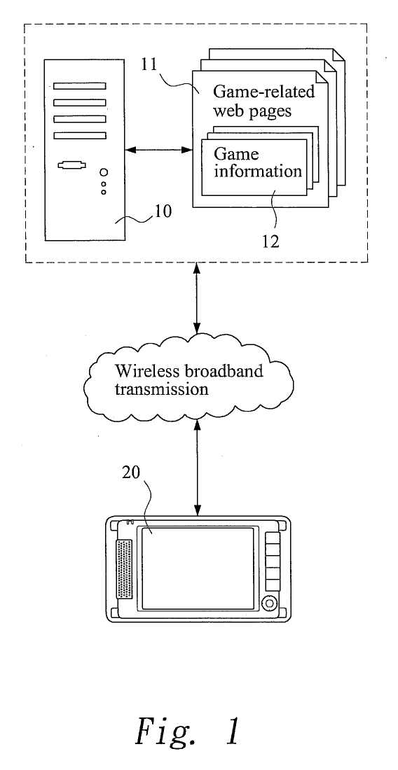

Please refer to FIG. 1 that shows a system configuration of an interactive live sports game watching system according to an embodiment of the present invention. By “live sports game”, it means various kinds of open exercises and athletics, and international matches, such as a baseball game held by Major League Baseball (MLB). With the interactive live sports game watching system of the present invention, a fan is able to know in real time the rules of a game being watched, basic information about the players participating in the game, historic events in connection with the players and the game, etc. Also, the interactive live sports game watching system allows the fan to predict the final result of an underway game, the scores obtained and/or lost by the parties in the game, etc., so that the fan is able to participate in the game deeply. As shown in FIG. 1, the interactive live sports game watching system includes a game web server 10 and at least one remote game watching device 20.

The game web server 10 is internally built a plurality of game-related web pages 11 based on various open exercises, athletics, and games. Each of the web pages 11 includes user-accessible game information 12 related to a particular game, including rules of the game, dates scheduled for the game, parties participating in the game, basic information about the game, historic events in connection with the game, etc.

The game watching device 20 not only enables a user to receive and watch live sports game telecasting in real time, but also allows the user to link with the game web server 10 to look for necessary game information 12 at any time. The live sports game telecasting received by the game watching device 20 may be real-time networked audio/video (AV) streaming media transmitted from the game web server 10, or live sports game telecasted via a DVB (digital TV) or a VHF/UHF TV.

The game watching device 20 of the present invention may be a handheld device, such as a 3G/3.5G mobile phone, a personal digital assistant (PDA), a handheld computer, a multimedia player, or a notebook computer, which combines with the wireless broadband transmission technique to link with the game web server 10. Therefore, the game watching device 20 may be linked with the game web server 10 via a 3G/3.5G mobile phone communication, a WiMAX wireless broadband transmission, etc. Alternatively, the game watching device 20 may be a stationary electronic machine fixedly mounted at a recreation resort and linked with the game web server 10 via an ADSL/Cable modem transmission.

The game-related web pages 11 built in the game web server 10 may be accessed by a user based on a membership. That is, when a user wants to enter the web pages 11 of the game web server 10 via the game watching device 20, the user has to input a registered membership account and password first. The game web server 10 may also allow the user to, via the game watching device 20, input personally predicted results of an underway game and/or bet corresponding membership points on the game. The predicted results of the underway game may include a predicted result of every remaining stage of the underway game and a predicted final result of the game. For example, the user may input a predicted score in the first five innings and/or a predicted final ratio of scores in MLB 2008 World Series NY Yankees vs. Cleveland Indians. The game web server 10 would then compare the predicted results with real results of the game, and count the points to be added to or deducted from the user's membership points. With these arrangements, the user may participate in the game with more fun.

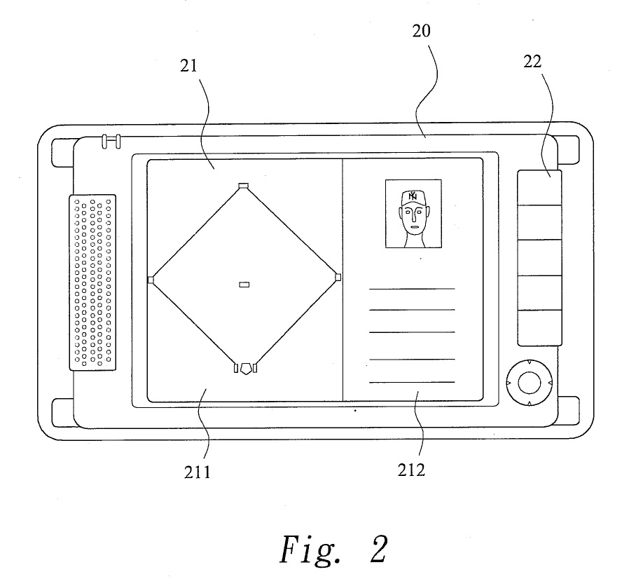

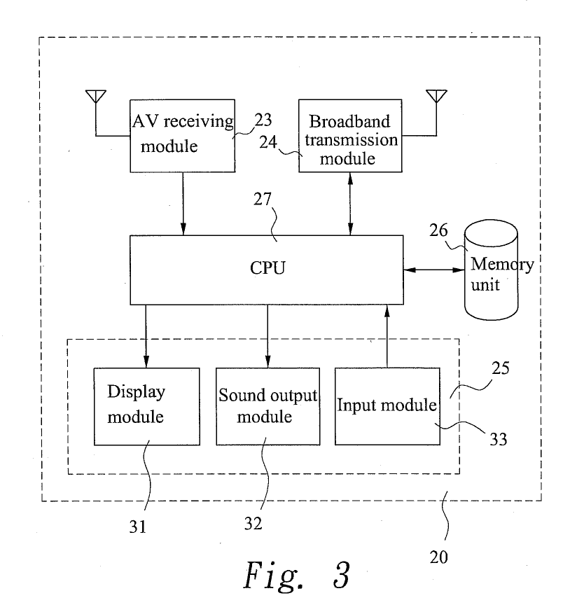

FIG. 2 is a front view of the live sports game watching device 20 according to an embodiment of the present invention, and FIG. 3 is a block diagram of the live sports game watching device 20 of FIG. 2. The following description is based on a handheld game watching device 20. As shown, the game watching device 20 includes a display panel 21, on which there is provided a playing window 211 for showing a live sports game, and/or a browsing window 212 for showing the game-related web pages 11. There is also a plurality of control keys 22 provided on the game watching device 20 for selecting a desired channel on the game watching device 20, selecting a desired option on one web page 11, or inputting related inquiries. The display panel 21 may be a touch panel allowing the user to control the game watching device 20 simply by touching the display panel 21.

Please refer to FIG. 3. In a hardware configuration for the game watching device 20, there is included an AV receiving module 23, a broadband transmission module 24, a user-interface 25, a memory unit 26, and a central processing unit (CPU) 27. The AV receiving module 23 is electrically connected to the CPU 27, and may be a DVB TV receiving module, a cable TV receiving module, an internet TV receiving module, or a VHF/UHF TV receiving module for receiving audio and video signals of live sports games.

The broadband transmission module 24 is electrically connected to the CPU 27, and may be a 3G/3.5G mobile phone communication module, a WiMAX wireless transmission module, an ADSL wire transmission module, a cable modem wire transmission module, or an optical fiber transmission module for linking with the game web server 10.

The user-interface 25 is an interface via which the user watches and controls the game watching device 20, and may include a display module 31, a sound output module 32, and an input module 33, all of which are electrically connected to the CPU 27. The display module 31 may be a LCD panel 21, on which live sports game telecasting may be shown and the web pages 11 may be browsed. The input module 33 may be control keys 22, including Up, Down, Left, Right cursor control keys, numeral keys, function keys, etc. The input module 33 may be otherwise a touch input panel of the display module 31.

The memory unit 26 is electrically connected to the CPU 27, and may include a nonvolatile memory and a random access memory (RAM). The nonvolatile memory has AV playing program and web page browsing program stored thereon; and the RAM is used to temporarily store the displayed images or the programs being executed by the CPU 27.

The CPU 27 is electrically connected to each of the above-mentioned modules 23, 24, 31, 32, 33, and is a control center of the game watching device 20 for running the AV playing program to play the telecasted live sports games, or running the web page browsing program for the user to browse the web pages 11. According to the game watching device 20 of the present invention, the display module 31 may include a playing window 211 for showing telecasted live sports games, and/or a browsing window 212 for showing the browsed game-related web pages 11. The user may operate on the input module 33 or on the touch panel 21 to search for game-related information 12 and show the game-related information 12 on the browsing window 212, or to enter predicted results of an underway game and bet corresponding membership points on the game.

With the above arrangements, the interactive live sports game watching system and game watching device therefor according to the present invention provide the following advantages:

1. The game web server 10 of the present invention is able to directly transmit, via a wideband network, different telecasted live sports games to the game watching device 20 to largely reduce the hardware cost needed for the game watching device 20.

2. The game web server 10 is also able to process the searches for game-related web pages 11 and compute an accuracy of the predicted results of game to add or deduct corresponding points to or from the user's membership points.

3. The live sports games being transmitted from the game web server 10 to the game watching device 20 are real fair open and/or international sports games, such as MLB baseball game, NBA basketball game, French Open, FIA Formula 1 Grand Prix World Championship, European Football Championship, Olympic games, etc., allowing the worldwide fans to participate in the games. And, the live sports game telecasting received by the game watching device is telecasted by a DVB digital TV or a VHF/UHF TV to reduce the use of data bandwidth.

4. The game watching device 20 allows the user to watch games while interacting with the game web server 10, such as searching for information about the players or the participating teams, historic events in connection with the games, or even viewing some wonderful fragments of such events.

5. The game web server 10 allows the user to predict via the game watching device 20 the results of the games at different stages thereof, including the final results or scores of the games, and adds or deducts points to or from the user's membership points to increase the fun in watching the games.

The present invention has been described with a preferred embodiment thereof and it is understood that many changes and modifications in the described embodiment can be carried out without departing from the scope and the spirit of the invention that is intended to be limited only by the appended claims.

What is claimed is:

1. An interactive live sports game watching device for receiving live sports game telecasting and linking with a game web server capable of providing various kinds of game information, comprising:
an AV receiving module for receiving audio and video signals of the live sports game telecasting;
a broadband transmission module for linking with the game web server; and
a user-interface including a display module and a sound output module for viewing and controlling the live sports game telecasting;
wherein the display module includes a playing window and/or a browsing window; the telecasted live sports game is viewed on the playing window, and the game information is shown on the browsing window.

2. The interactive live sports game watching device as claimed in claim 1, wherein the AV receiving module is selected from the group consisting of a DVB TV receiving module, a cable TV receiving module, a internet TV receiving module, or a VHF/UHF TV receiving module.

3. The interactive live sports game watching device as claimed in claim 1, wherein the broadband transmission module is selected from the group consisting of a 3G/3.5G mobile phone communication module, a WiMAX wireless transmission module, an ADSL wire transmission module, a cable modem wire transmission module, or an optical fiber transmission module.

4. The interactive live sports game watching device as claimed in claim 1, wherein the user-interface further includes an input module; and through operation on the input module, a user is allowed to search for and show the game information on the browsing window, or to enter predicted results of an underway game and bet corresponding membership points on the game.

5. The interactive live sports game watching device as claimed in claim 4, wherein the input module is a touch input panel of the display module.

6. The interactive live sports game watching device as claimed in claim 4, wherein the input module includes a plurality of control keys, including Up, Down, Left, and Right cursor control keys, numeral keys, and function keys.

7. The interactive live sports game watching device as claimed in claim 1, further comprising:
a memory unit including a nonvolatile memory for storing an AV playing program and a web page browsing program, and a RAM for temporarily storing displayed images and programs being run; and
a CPU being electrically connected to the AV receiving module, the wideband network module, the human-machine interface, and the memory unit for running the AV playing program and the web page browsing program.

8. The interactive live sports game watching device as claimed in claim 1, wherein the game watching device is selected from the group consisting of a handheld electronic device and a stationary electronic machine fixedly mounted at a recreational resort.

9. An interactive live sports game watching system, comprising:
a game web server being internally built a plurality of game-related web pages, and each of the web pages including user-accessible game information related to a particular game; the game web server allowing a user to input personally predicted results of an underway game and bet corresponding membership points on the game, and then comparing the predicted results with real results of the game and counting points to be added to or deducted from the user's membership points; and
at least one remote game watching device being linked with the game web server for receiving a live sports game telecasting from the game web server, entering the game-related web pages, searching for related game information, or inputting predicted results of an underway game and betting corresponding membership points on the game.

10. The interactive live sports game watching system as claimed in claim 9, wherein the game-related web pages are built based on various kinds of games, including open exercises, athletics, and international matches.

11. The interactive live sports game watching system as claimed in claim 9, wherein the game information includes rules of games, dates scheduled for different games, parties participating in the games, basic information about the games, and historic events in connection with the games.

12. The interactive live sports game watching system as claimed in claim 9, wherein the live sports game telecasting received by the game watching device is real-time networked AV streaming media transmitted from the game web server.

13. The interactive live sports game watching system as claimed in claim 9, wherein the live sports game telecasting received by the game watching device is telecasted by a DVB TV or a VHF/UHF TV.

14. The interactive live sports game watching system as claimed in claim 9, wherein the user is allowed to enter the game-related web pages in the game web server when a registered personal account and password are input.

15. The interactive live sports game watching system as claimed in claim 9, wherein the game watching device is a handheld electronic device linked with the game web server via either a 3G/3.5G mobile phone communication or a WiMAX wireless broadband transmission.

16. The interactive live sports game watching system as claimed in claim 9, wherein the game watching device is a stationary electronic machine fixedly mounted at a recreational resort and linked with the game web server via an ADSL/Cable Modem transmission.

17. The interactive live sports game watching system as claimed in claim 9, wherein the predicted results of an underway game include a predicted result of every remaining stage of the underway game and a predicted final result of the game.
